(19) United States
(12) Patent Application Publication
(10) Pub. No.: US 2025/0391407 A1
(43) Pub. Date: Dec. 25, 2025

(54) METHOD AND COMPUTER DEVICE FOR IMPLEMENTING SPEECH-TO-TEXT CONVERSION ON SPEECH IN A SINO-TIBETAN LANGUAGE

(71) Applicant: MAX CHOICE LTD., Victoria (SC)

(72) Inventor: Kuo-Fong JUAN, New Taipei City (TW)

(21) Appl. No.: 19/244,429

(22) Filed: Jun. 20, 2025

(30) Foreign Application Priority Data
Jun. 24, 2024 (TW) 113123440

(51) Int. Cl. G10L 15/26; G06N 3/044; G06N 3/08; G10L 25/30

(52) U.S. Cl. CPC G10L 15/26; G06N 3/044; G06N 3/08; G10L 25/30

(57) ABSTRACT

A method for implementing speech-to-text conversion on an input speech file in a Sino-Tibetan language includes: obtaining a plurality of input speech segments in a sequential order, and, for each input speech segment of the plurality of input speech segments, a number of input speech feature vectors related to the input speech segment; generating, for each input speech segment, a to-be-processed speech feature vector based on the input speech feature vectors corresponding to the input speech segment; sequentially processing the input speech segments to obtain a sequence of converted strings, respectively; and obtaining a finalized converted text transcription based on the converted strings.

### CROSS-REFERENCE TO RELATED APPLICATION

This application claims priority to Taiwanese Invention patent application No. 113123440, filed on Jun. 24, 2024, the entire disclosure of which is incorporated by reference herein.

### FIELD

The disclosure relates to a method and a computer device for implementing speech to text, and more particularly to a method and a computer device for implementing speech-to-text conversion on speech in a Sino-Tibetan language.

### BACKGROUND

The term “Sino-Tibetan languages” typically refers to a family of about 400 languages, collectively natively spoken by about 1.5 billion people globally, second only to Indo-European languages. In many territories, the Sino-Tibetan languages are widely spoken by the residents. For example, in Taiwan, the Mandarin Chinese languages and Southern Min languages included in the Sino-Tibetan languages are the most commonly used languages.

As the techniques in the field of computer learning advance, speech-to-text conversion has been utilized widely for communication proposes. It is noted that speech-to-text conversion on most languages included in the Sino-Tibetan languages are currently not supported by many of the currently available conversion products, and the results from the conversion products that support the Sino-Tibetan languages are generated with a relatively low accuracy, and therefore may need further human verification, which reduces the efficiency of the conversion products.

### SUMMARY

It is therefore desired to provide a method for implementing speech-to-text conversion on an input speech file in a Sino-Tibetan language.

Therefore, one object of the disclosure is to provide a method that can alleviate at least one of the drawbacks of the prior art.

According to one embodiment of the disclosure, the method for implementing speech-to-text conversion on an input speech file in a Sino-Tibetan language is implemented using a computer device and includes steps of:
a) in response to receipt of the input speech file, processing the input speech file so as to obtain a plurality of input speech segments that are in a sequential order;
b) obtaining, for each input speech segment of the plurality of input speech segments, a number of input speech feature vectors that are arranged in the sequential order and that are related to the input speech segment using a speech feature extraction algorithm;
c) generating, for each input speech segment of the plurality of input speech segments, a to-be-processed speech feature vector based on the input speech feature vectors that correspond to the input speech segment, resulting in a plurality of to-be-processed speech feature vectors;
d) using a speech recognition model to sequentially process the plurality of input speech segments to obtain a sequence of converted strings in a natural language, respectively; and
e) obtaining a finalized converted text transcription based on the converted strings.

Another object of the disclosure is to provide a computer device that is configured to implement the above-mentioned method.

According to one embodiment of the disclosure, the computer device for implementing speech-to-text conversion on an input speech file in a Sino-Tibetan language includes a data storage, a display unit and a processor connected to the data storage and the display unit. The processor is programmed to:
in response to receipt of the input speech file, process the input speech file so as to obtain a plurality of input speech segments that are in a sequential order;
obtain, for each input speech segment of the plurality of input speech segments, a number of input speech feature vectors that are arranged in the sequential order and that are related to the input speech segment using a speech feature extraction algorithm;
generate, for each input speech segment of the plurality of input speech segments, a to-be-processed speech feature vector based on the input speech feature vectors that correspond to the input speech segment, resulting in a plurality of to-be-processed speech feature vectors;
use a speech recognition model to sequentially process the plurality of input speech segments to obtain a sequence of converted strings in a natural language, respectively; and
obtain a finalized converted text transcription based on the converted strings.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram of a computer device for implementing a method for speech-to-text conversion according to one embodiment of the disclosure.

FIG. 2 is a flow chart illustrating steps of an exemplary first model training process of the method according to one embodiment of the disclosure.

FIGS. 3 and 4 illustrate a flow chart illustrating steps of an exemplary second model training process of the method according to one embodiment of the disclosure

FIG. 5 is a flow chart illustrating steps of an exemplary third model training process of the method according to one embodiment of the disclosure.

FIG. 6 is a flow chart illustrating steps of an exemplary speech-to-text conversion process of the method according to one embodiment of the disclosure.

FIG. 7 illustrates an example of a sentence containing three converted strings being strung together.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

Throughout the disclosure, the term “Sino-Tibetan languages” refers to a family of about 400 different languages, and includes the family of Chinese Han languages and the family of Tibeto-Burman languages. The family of Sino-Tibetan languages includes popular languages such as Chinese Han language, Taiwanese Hokkien (also known as Taigi), Tibetic language, Burmese, Yi language, etc., and are commonly used in Asian countries such as China (including Hong Kong and Macau), Taiwan, Myanmar, Bhutan, Nepal, India, Singapore, Malaysia, etc. In the embodiments, the language of Southern Min language (also known as Minnan language) is used as an exemplary language, but it should be noted that the embodiments of the disclosure may be applied to other languages included in the family of Sino-Tibetan languages.

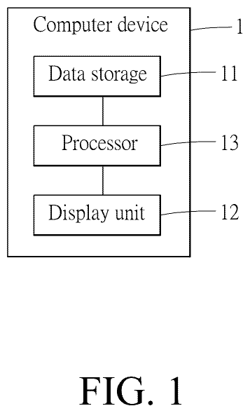

FIG. 1 is a block diagram of a computer device 1 for implementing a method for speech-to-text conversion according to one embodiment of the disclosure. In this embodiment, the computer device 1 may be embodied using a personal computer, a laptop, a tablet, a smartphone, or other suitable electronic devices.

The computer device 1 includes a data storage 11, a display unit 12, and a processor 13. The data storage 11 may be embodied using, for example, random access memory (RAM), read only memory (ROM), programmable ROM (PROM), firmware, flash memory or other suitable non-transitory storage media. In this embodiment, the data storage unit 11 stores a software application therein. The software application includes instructions that, when executed by the processor 13, cause the processor 13 to implement the operations as described below.

In addition, the data storage unit 11 includes a database that stores a plurality of training speech segments, a plurality of natural language texts that are associated respectively with the training speech segments, and a plurality of training semantic datasets.

Each of the training speech segments may be obtained from one or more speech audio files. For example, in some embodiments, each of the speech audio files may be a recording of speech in the Minnan language. Each of the natural language texts includes a text transcription of the corresponding one of the training speech segments in a natural language, such as Mandarin. Each of the training semantic datasets includes a semantically incorrect sentence in the natural language and a semantically correct sentence that corresponds with the semantically incorrect sentence in the natural language.

In embodiments, each of the natural language texts may be in Mandarin, and includes a sequence of words. Each of the words may be constituted of one or more traditional Chinese characters. The sequence of words may form one or more sentences. Each semantically incorrect sentence and each semantically correct sentence may also include a sequence of words.

In some embodiments, the training speech segments are obtained from existing databases. For example, in some embodiments, the available databases include the Taiwanese-Corpus repositories that are available on the website of the GitHub platform (https://github.com/Taiwanese-Corpus) and that contain a number of public documents, and the “twasis2017” database that contains about 212 hours of speech from conversations in dramas, news broadcast and talk shows in the Minnan language, with the proper associated texts. It is noted that in other embodiments, content from other databases may be employed to obtain the training speech segments.

The display unit 12 may be embodied using a standalone display screen or a touchscreen, and may be controlled by the processor 13 to display content.

The processor 13 is electrically connected to the data storage 11 and the display unit 12, and may be embodied using a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

In use, the computer device 1 is programmed to implement a method for implementing speech-to-text conversion on speech in a Sino-Tibetan language. In some embodiments, the method for implementing speech-to-text conversion on speech in a Sino-Tibetan language includes a first model training process, a second model training process, a third model training process, and a speech-to-text conversion process.

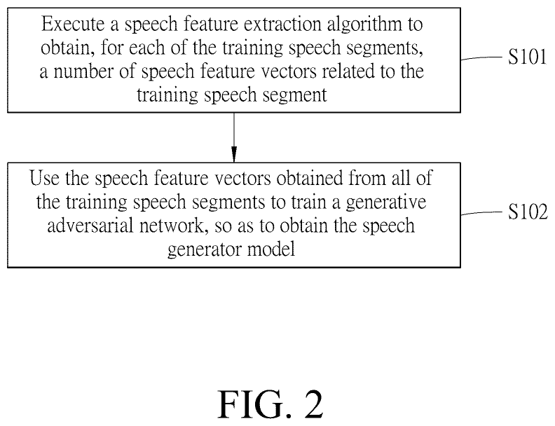

FIG. 2 is a flow chart illustrating steps of an exemplary first model training process 100 of the method according to one embodiment of the disclosure. In some embodiments, the first model training process 100 is implemented using the computer device 1 of FIG. 1 and is for training a speech generator model and a speech discriminator model. The speech generator model is for generating a generated speech feature vector from one of the training speech segments.

In step S101, the processor 13 executes a speech feature extraction algorithm to obtain, for each of the training speech segments, a number of speech feature vectors related to the training speech segment. In this embodiment, the speech feature extraction algorithm may be an algorithm that involves a Mel-Frequency Cepstral Coefficients (MFCCs) technique, but different algorithms may also be employed in other embodiments. In this embodiment, the training speech segments may be associated with multiple speech feature vectors as multiple traditional Chinese characters may be associated with the same pronunciation.

In step S102, the processor 13 uses the speech feature vectors obtained from all of the training speech segments to train a generative adversarial network, so as to obtain the speech generator model and the speech discriminator model. In this embodiment, the generative adversarial network may be a speech enhancement generative adversarial network (SEGAN), but different generative adversarial networks may be employed in other embodiments. As such, the first model training process 100 is completed.

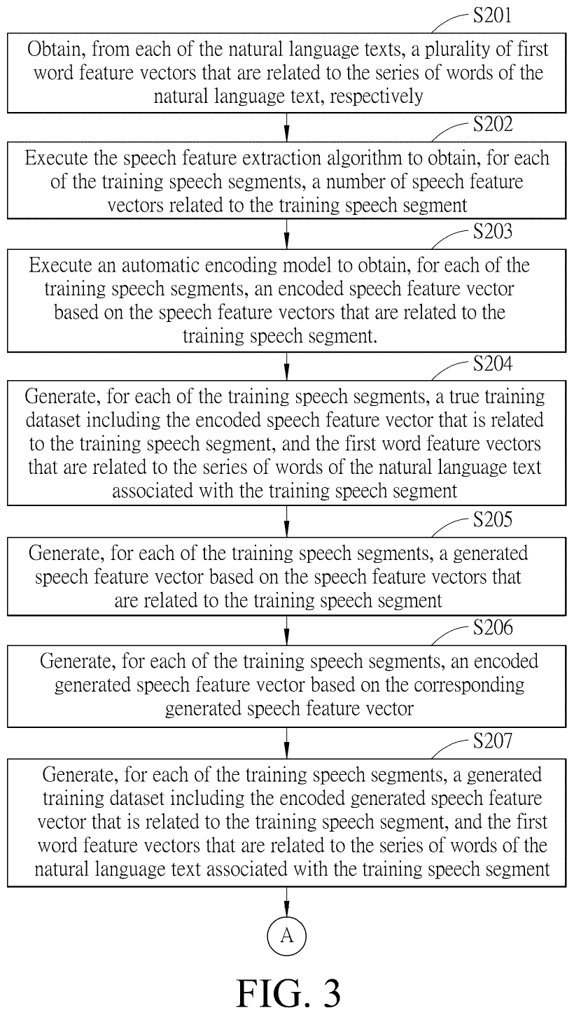

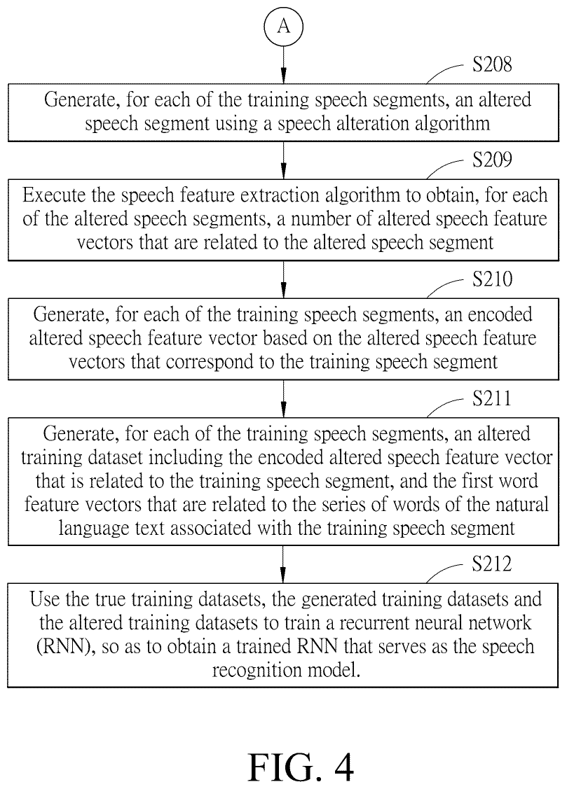

FIGS. 3 and 4 illustrate a flow chart illustrating steps of an exemplary second model training process 200 of the method according to one embodiment of the disclosure. In some embodiments, the second model training process 200 is implemented using the computer device 1 of FIG. 1 and is for training a speech recognition model. In particular, the speech recognition model may be for use in speech recognition in a Sino-Tibetan language.

In step S201, the processor 13 obtains, from each of the natural language texts, a plurality of first word feature vectors that are related to the series of words of the natural language text, respectively. It is noted that obtaining the first word feature vector may be done using a manner that is known in the related art, and therefore details thereof are omitted herein for the sake of brevity.

In step S202, the processor 13 executes the speech feature extraction algorithm to obtain, for each of the training speech segments, a number of speech feature vectors related to the training speech segment.

In step S203, the processor 13 executes an automatic encoding model to obtain, for each of the training speech segments, an encoded speech feature vector based on the speech feature vectors that are related to the training speech segment.

In step S204, the processor 13 generates, for each of the training speech segments, a true training dataset including the encoded speech feature vector that is related to the training speech segment, and the first word feature vectors that are related to the series of words of the natural language text associated with the training speech segment. As a result, a plurality of true training datasets corresponding respectively to the training speech segments are obtained in this step.

In step S205, the processor 13 generates, for each of the training speech segments, a generated speech feature vector based on the speech feature vectors that are related to the training speech segment. As a result, a plurality of generated speech feature vectors corresponding respectively to the training speech segments are obtained in this step. It is noted that, in this embodiment, the generated speech feature vectors are generated using the speech generator model trained in the first model training process 100. It is noted that the operations of steps S204 and S205 may be implemented in an arbitrary order, and are not necessarily done in the order as described above.

In step S206, the processor 13 generates, for each of the training speech segments, an encoded generated speech feature vector based on the corresponding generated speech feature vector. As a result, a plurality of encoded generated speech feature vectors corresponding respectively to the training speech segments are obtained in this step. It is noted that, in this embodiment, the encoded generated speech feature vector is generated using the automatic encoding model.

In step S207, the processor 13 generates, for each of the training speech segments, a generated training dataset including the encoded generated speech feature vector that is related to the training speech segment, and the first word feature vectors that are related to the series of words of the natural language text associated with the training speech segment. As a result, a plurality of generated training datasets corresponding respectively to the training speech segments are obtained in this step.

It is worth noting that, in this embodiment, the generated training datasets are generated using the speech generator model trained in the first model training process 100, and the generated training datasets may serve as additional data for the subsequent training operations. This may be particularly useful in the case that the amount of data used for training is insufficient, resulting in a reduced accuracy for the trained model.

In step S208, the processor 13 generates, for each of the training speech segments, an altered speech segment using a speech alteration algorithm. As a result, a plurality of altered speech segments corresponding respectively to the training speech segments are obtained in this step. It is noted that the speech alteration algorithm may be used to adjust a tone and/or a speed of speech of the training speech segment, and a commercially available speech alteration algorithm may be employed in embodiments.

In step S209, the processor 13 executes the speech feature extraction algorithm to obtain, for each of the altered speech segments, a number of altered speech feature vectors that are related to the altered speech segment. It is noted that the operations of step S209 may be implemented in a manner similar to that of the operations of step S202.

In step S210, the processor 13 generates, for each of the training speech segments, an encoded altered speech feature vector based on the altered speech feature vectors that correspond to the training speech segment. As a result, a plurality of encoded altered speech feature vectors corresponding respectively to the training speech segments are obtained in this step. It is noted that, in this embodiment, the encoded altered speech feature vectors are generated using the automatic encoding model.

Then, in step S211, the processor 13 generates, for each of the training speech segments, an altered training dataset including the encoded altered speech feature vector that is related to the training speech segment, and the first word feature vectors that are related to the series of words of the natural language text associated with the training speech segment. As a result, a plurality of altered training datasets corresponding respectively to the training speech segments are obtained in this step.

It is worth noting that, in this embodiment, the altered training datasets are generated using the speech generator model trained in the first model training process 100, and the altered training datasets may serve as additional data for the subsequent training operations. This may be particularly useful in the case that the amount of data used for training is insufficient, resulting in a reduced accuracy for the trained model.

It is noted that in embodiments, the automatic encoding model employed in the above processes may be based on the Denoising AutoEncoder (DAE) serving as a backbone and trained using various data generated throughout the processes of the method (such as the speech feature vectors obtained in step S101, the generated speech feature vectors obtained in step S205, and the altered speech feature vectors obtained in step S209, etc.) in an unsupervised learning framework. Generally, the automatic encoding model has the effects of noise reduction and dimension reduction, and the encoded speech feature vector generated thereby may have a reduced dimension. As such, by processing the data used for training the various models, the resources needed for training the models may be reduced.

In step S212, the processor 13 uses the true training datasets, the generated training datasets and the altered training datasets to train a recurrent neural network (RNN), so as to obtain a trained RNN that serves as the speech recognition model. In some embodiments, the RNN may be a long short-term memory (LSTM) type, or other types in other embodiments. It is noted that, in some embodiments, the operations of step S212 may involve using only the true training datasets and the generated training datasets to train the RNN.

As such, the second training process 200 for the speech recognition model is completed.

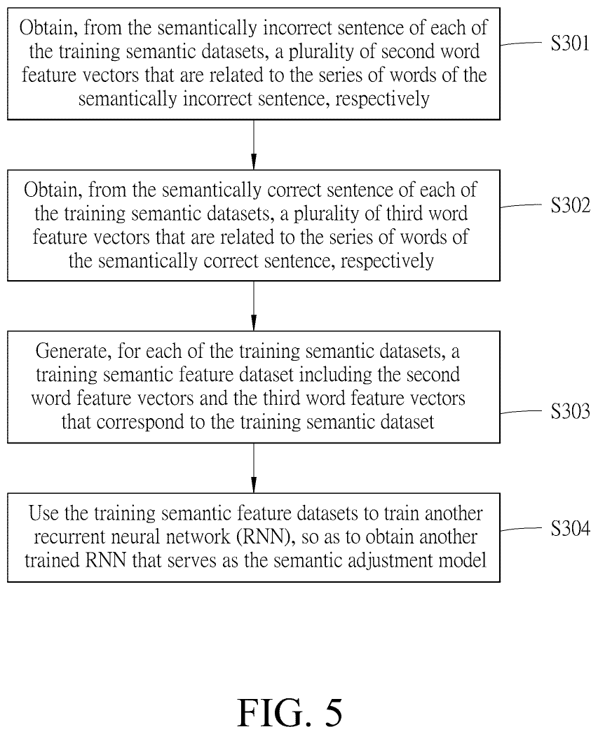

FIG. 5 is a flow chart illustrating steps of an exemplary third model training process 300 of the method according to one embodiment of the disclosure. In some embodiments, the third model training process 300 is implemented using the computer device 1 of FIG. 1 and is for training a semantic adjustment model. In particular, the semantic adjustment model may be for use in semantic adjustment in a Sino-Tibetan language.

It is noted that the third model training process 300 is not necessarily implemented after the first model training process 100 and the second model training process 200.

In step S301, the processor 13 obtains, from the semantically incorrect sentence of each of the training semantic datasets, a plurality of second word feature vectors that are related to the series of words of the semantically incorrect sentence, respectively.

In step S302, the processor 13 obtains, from the semantically correct sentence of each of the training semantic datasets, a plurality of third word feature vectors that are related to the series of words of the semantically correct sentence, respectively. It is noted that in embodiments, obtaining the second word feature vectors and the third word feature vectors may be done in a manner that is known in the related art, and therefore details thereof are omitted herein for the sake of brevity.

In step S303, the processor 13 generates, for each of the training semantic datasets, a training semantic feature dataset including the second word feature vectors and the third word feature vectors that correspond to the training semantic dataset. As a result, a plurality of training semantic feature datasets corresponding respectively to the training semantic datasets are obtained by steps S301 to S303.

In step S304, the processor 13 uses the training semantic feature datasets to train another recurrent neural network (RNN), so as to obtain another trained RNN that serves as the semantic adjustment model. In some embodiments, the RNN may be a long short-term memory (LSTM) type, or other types in other embodiments. In some cases, the semantic adjustment model may include a large language model (LLM).

As such, the third training process 300 for the semantic adjustment model is completed.

At this stage, in response to receipt of a speech file containing speech in a Sino-Tibetan language, the speech-to-text conversion process may be implemented so as to obtain a text transcription of the speech contained in the speech file in a natural language.

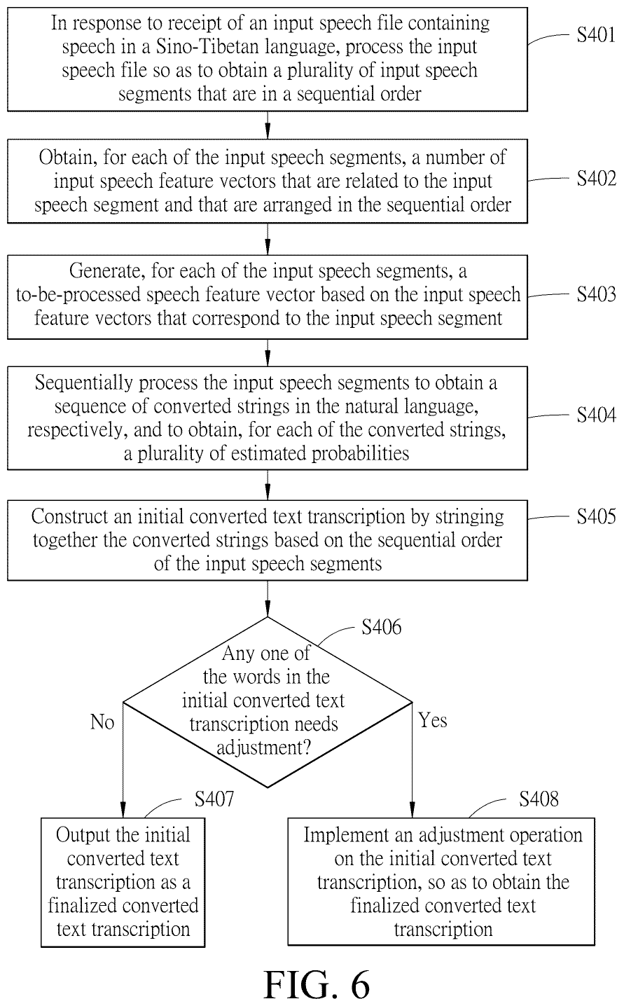

FIG. 6 is a flow chart illustrating steps of an exemplary speech-to-text conversion process 400 of the method according to one embodiment of the disclosure. In some embodiments, the speech-to-text conversion process 400 is implemented using the computer device 1 of FIG. 1 with the speech recognition model and the automatic encoding model prepared. In some embodiments, the computer device 1 may be, for example, a mobile device held by a user, and is pre-stored with the speech recognition model and the semantic adjustment model.

In step S401, in response to receipt of an input speech file containing speech in a Sino-Tibetan language, the processor 13 processes the input speech file so as to obtain a plurality of input speech segments that are in a sequential order. In embodiments, the processor 13 may divide the speech of the input speech file into a number of input speech segments each having a preset length (e.g., 5 to 10 seconds). The input speech segments are arranged in an order that corresponds with the speech of the input speech file.

In step S402, the processor 13 executing the speech feature extraction algorithm obtains, for each of the input speech segments, a number of input speech feature vectors that are related to the input speech segment and that are arranged in the sequential order. It is noted that the operations of step S402 may be done in a manner similar to that of step S202.

In step S403, the processor 13 generates, for each of the input speech segments, a to-be-processed speech feature vector based on the input speech feature vectors that correspond to the input speech segment. As a result, a plurality of to-be-processed speech feature vectors corresponding respectively to the input speech segments are obtained in this step. It is noted that, in this embodiment, the to-be-processed speech feature vectors are generated using the automatic encoding model.

In step S404, the processor 13 sequentially processes the input speech segments to obtain a sequence of converted strings in the natural language, respectively. In this step, the processor 13 further obtains, for each of the converted strings, a plurality of estimated probabilities.

In use, the operations of step S404 may be the processor 13 using the speech recognition model trained in the second training process 200 to process the to-be-processed speech feature vectors corresponding to the input speech segments.

Each converted string includes a sequence of words, and each of the estimated probabilities is associated with one of the words included in the converted string. Generally, in different embodiments, the estimated probabilities may be a preset number related to a source of the sequence of converted strings. In some embodiments, when the source of the sequence of converted strings is from the input speech segments, the estimated probabilities may be 0.5 or other numbers.

In step S405, the processor 13 constructs an initial converted text transcription by stringing together the converted strings based on the sequential order of the input speech segments. Similar to the converted strings, the initial converted text transcription includes a plurality of words.

Then, in step S406, the processor 13 determines whether any one of the words in the initial converted text transcription needs adjustment. Specifically, the processor 13 determines whether each of the estimated probabilities (associated with one of the words) is below a predetermined probability threshold, and in the case that one of the estimated probabilities is below the predetermined probability threshold, it may be deduced that the associated one of the words needs to be adjusted.

In some embodiments, since the input speech segments are divided based on time instances, the content of a word with multiple syllables (i.e., a word having multiple characters) may be included in two successive input speech segments. As such, the resulting converted strings may be semantically incorrect. In addition, other errors may occur that lead to the converted string being semantically incorrect. For example, the converted strings are in the natural language of Mandarin in some embodiments, and since multiple Traditional Chinese character may have the same pronunciation, in determining the texts included in the converted string, incorrect Traditional Chinese characters may be employed, resulting in nonsensical sentences that may “read” like the speech. As such, the initial converted text transcription may need additional checkup to eliminate the potential errors.

In the case that none of the words in the initial converted text transcription need adjustment, the flow proceeds to step S407. Otherwise, in the case that at least one of the estimated probabilities is below the predetermined probability threshold, it is determined that at least one of the words in the initial converted text transcription needs adjustment, and the flow proceeds to step S408.

In step S407, the processor 13 outputs the initial converted text transcription as a finalized converted text transcription. In embodiments, the finalized converted text transcription may be stored in the data storage 11, transmitted to a cloud server via a network (e.g., the Internet), and/or displayed on the display unit 12.

In step S408, the processor 13 implements an adjustment operation on the initial converted text transcription, so as to obtain the finalized converted text transcription. In embodiments, the adjustment operation may be implemented using the semantic adjustment model. In the adjustment operation, the semantic adjustment model may be employed to determine whether incorrect Traditional Chinese character are present, and whether the words bridging two converted strings make semantical sense.

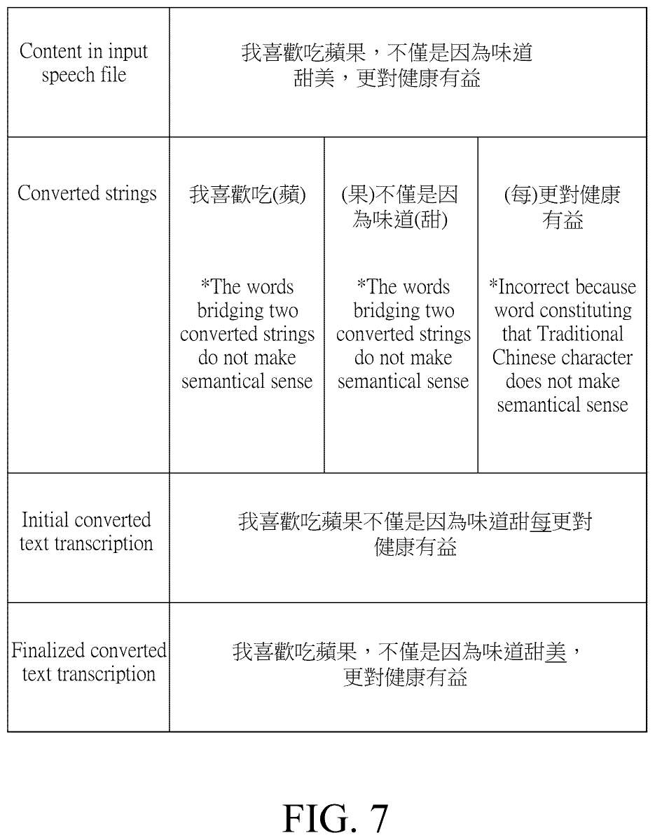

FIG. 7 illustrates an example of a sentence in the natural language in the input speech file, containing three converted strings that are to be strung together. In step S406, it is noted that one of the Traditional Chinese characters is deemed incorrect because a word constituted of that Traditional Chinese character does not make semantical sense. As such, the semantic adjustment model may be employed to determine another Traditional Chinese character to replace the one of the Traditional Chinese characters, so as to result in a word that makes semantical sense. Afterwards, the finalized converted text transcription may be obtained, and the flow proceeds to step S408. As such, the text to speech process is completed.

To sum up, embodiments of the disclosure provide a method for implementing speech-to-text conversion on speech in a Sino-Tibetan language. In the method, a number of training processes are first implemented to prepare a speech generator model, a speech recognition model and a semantic adjustment model. Afterward, in response to receipt of an input speech file, a computer device is configured to processes the input speech file so as to obtain a plurality of sequential input speech segments, and to generate a plurality of to-be-processed speech feature vectors. Then, the computer device generates a plurality of converted strings in the natural language and a plurality of estimated probabilities associated with each of the converted strings using the speech recognition model. Then, the computer device obtains an initial converted text transcription by stringing the converted strings together, and determines whether the initial converted text transcription needs any adjustment. In the case that it is determined the initial converted text transcription needs any adjustment, the computer device then implements an adjustment operation on the initial converted text transcription, so as to obtain a finalized converted text transcription. In this manner, the content of the input speech file, which is in a Sino-Tibetan language, may be outputted as a text transcription with an increased accuracy.

Additionally, in embodiments, the output of the speech generator model and the speech alteration algorithm may serve as additional data for the subsequent training operations, which may further increase the performance of the speech recognition model.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for implementing speech-to-text conversion on an input speech file in a Sino-Tibetan language, the method being implemented using a computer device and comprising steps of:
a) in response to receipt of the input speech file, processing the input speech file so as to obtain a plurality of input speech segments that are in a sequential order;
b) obtaining, for each input speech segment of the plurality of input speech segments, a number of input speech feature vectors that are arranged in the sequential order and that are related to the input speech segment using a speech feature extraction algorithm;
c) generating, for each input speech segment of the plurality of input speech segments, a to-be-processed speech feature vector based on the input speech feature vectors that correspond to the input speech segment, resulting in a plurality of to-be-processed speech feature vectors;
d) using a speech recognition model to sequentially process the plurality of input speech segments to obtain a sequence of converted strings in a natural language, respectively; and
e) obtaining a finalized converted text transcription based on the converted strings.

2. The method as claimed in claim 1, the computer device storing a plurality of training speech segments, a plurality of natural language texts that are associated respectively with the plurality of training speech segments, each of the plurality of natural language texts including a sequence of words, the method further comprising, prior to step d), the steps of:
f) obtaining, from each natural language text of the plurality of natural language texts, a plurality of first word feature vectors that are related to the series of words of the natural language text, respectively;
g) obtaining, for each training speech segment of the plurality of training speech segments, a number of speech feature vectors related to the training speech segment using the speech feature extraction algorithm;
h) using an automatic encoding model to obtain, for each training speech segment of the plurality of training speech segments, an encoded speech feature vector based on the number of speech feature vectors that are related to the training speech segment;
i) generating, for each training speech segment of the plurality of training speech segments, a true training dataset including the encoded speech feature vector that is related to the training speech segment, and the first word feature vectors that are related to the series of words of the natural language text associated with the training speech segment, resulting in a plurality of true training datasets that correspond respectively to the plurality of training speech segments;
j) using a speech generator model to generate, for each training speech segment of the plurality of training speech segments, a generated speech feature vector based on the number of speech feature vectors that are related to the training speech segment, resulting in a plurality of generated speech feature vectors that correspond respectively to the plurality of training speech segments; and
k) using the automatic encoding model to generate, for each training speech segment of the plurality of training speech segments, an encoded generated speech feature vector based on the generated speech feature vector that corresponds to the training speech segment, resulting in a plurality of encoded generated speech feature vectors that correspond respectively to the plurality of training speech segments;
l) generating, for each training speech segment of the plurality of training speech segments, a generated training dataset including the encoded generated speech feature vector that is related to the training speech segment, and the plurality of first word feature vectors that are related to the series of words of the natural language text associated with the training speech segment, resulting in a plurality of generated training datasets that correspond respectively to the plurality of training speech segments; and
m) using the plurality of true training datasets and the plurality of generated training datasets to train a recurrent neural network (RNN), so as to obtain a trained RNN that serves as the speech recognition model.

3. The method as claimed in claim 2, further comprising, between steps g) and j), a step of using the plurality of speech feature vectors to train a generative adversarial network, so as to obtain the speech generator model.

4. The method as claimed in claim 2, further comprising, prior to step m), steps of:
n) generating, for each training speech segment of the plurality of training speech segments, an altered speech segment using a speech alteration algorithm, resulting in a plurality of altered speech segments that correspond respectively to the plurality of training speech segments;
o) obtaining, for each altered speech segment of the plurality of altered speech segments, a number of altered speech feature vectors that are related to the altered speech segment using the speech feature extraction algorithm;
p) generating, for each training speech segment of the plurality of training speech segments, an encoded altered speech feature vector based on the number of altered speech feature vectors that correspond to the training speech segment;
q) generating, for each training speech segment of the plurality of training speech segments, an altered training dataset including the encoded altered speech feature vector that is related to the training speech segment, and the first word feature vectors that are related to the series of words of the natural language text associated with the training speech segment, resulting in a plurality of altered training datasets;
wherein, in step m), the RNN is trained further using the plurality of altered training datasets.

5. The method as claimed in claim 1, wherein:
step d) further includes obtaining, for each of the converted string, a plurality of estimated probabilities;
step e) includes
r) constructing an initial converted text transcription by stringing together the converted strings based on the sequential order of the plurality of input speech segments,
s) determining whether any one of the words in the initial converted text transcription needs adjustment by determining whether each of the plurality of estimated probabilities is below a predetermined probability threshold, and
t) in the case that at least one of the plurality of estimated probabilities is below the predetermined probability threshold, implementing an adjustment operation on the initial converted text transcription, so as to obtain the finalized converted text transcription.

6. The method as claimed in claim 5, the computer device further storing a plurality of training semantic datasets, each of the plurality of training semantic datasets including a semantically incorrect sentence and a semantically correct sentence that corresponds with the semantically incorrect sentence, each of the semantically incorrect sentence and the semantically correct sentence including a sequence of words, the method further comprising, prior to step t), steps of:
obtaining, from the semantically incorrect sentence of each of the plurality of training semantic datasets, a plurality of second word feature vectors that are related to the series of words of the semantically incorrect sentence, respectively;
obtaining, from the semantically correct sentence of each of the plurality of training semantic datasets, a plurality of third word feature vectors that are related to the series of words of the semantically correct sentence, respectively;
generating, for each training semantic dataset of the plurality of training semantic datasets, a training semantic feature dataset including the second word feature vectors and the third word feature vectors that correspond to the training semantic dataset, resulting in a plurality of training semantic feature datasets corresponding respectively to the plurality of training semantic datasets; and
using the training semantic feature datasets to train another RNN, so as to obtain another trained RNN that serves as a semantic adjustment model;
wherein step t) is implemented using the semantic adjustment model.

7. The method as claimed in claim 5, wherein step e) further includes, in the case that none of the words in the initial converted text transcription need adjustment, outputting the initial converted text transcription as the finalized converted text transcription.

8. The method as claimed in claim 5, wherein step t) is implemented using a semantic adjustment model that includes a large language model (LLM).

9. A computer device for implementing speech-to-text conversion on an input speech file in a Sino-Tibetan language, comprising a data storage, a display unit and a processor connected to the data storage and the display unit, wherein the processor is programmed to:
in response to receipt of the input speech file, process the input speech file so as to obtain a plurality of input speech segments that are in a sequential order;
obtain, for each input speech segment of the plurality of input speech segments, a number of input speech feature vectors that are arranged in the sequential order and that are related to the input speech segment using a speech feature extraction algorithm;
generate, for each input speech segment of the plurality of input speech segments, a to-be-processed speech feature vector based on the input speech feature vectors that correspond to the input speech segment, resulting in a plurality of to-be-processed speech feature vectors;
use a speech recognition model to sequentially process the plurality of input speech segments to obtain a sequence of converted strings in a natural language, respectively; and
obtain a finalized converted text transcription based on the converted strings.

10. The computer device as claimed in claim 9, wherein:
the data storage stores a plurality of training speech segments, a plurality of natural language texts that are associated respectively with the plurality of training speech segments, each of the plurality of natural language texts including a sequence of words;
the processor is further programmed to, prior to obtaining the sequence of converted strings
obtain, from each natural language text of the plurality of natural language texts, a plurality of first word feature vectors that are related to the series of words of the natural language text, respectively,
obtain, for each training speech segment of the plurality of training speech segments, a number of speech feature vectors related to the training speech segment using the speech feature extraction algorithm,
use an automatic encoding model to obtain, for each training speech segment of the plurality of training speech segments, an encoded speech feature vector based on the number of speech feature vectors that are related to the training speech segment,
generate, for each training speech segment of the plurality of training speech segments, a true training dataset including the encoded speech feature vector that is related to the training speech segment, and the first word feature vectors that are related to the series of words of the natural language text associated with the training speech segment, resulting in a plurality of true training datasets that correspond respectively to the plurality of training speech segments,
use a speech generator model to generate, for each training speech segment of the plurality of training speech segments, a generated speech feature vector based on the number of speech feature vectors that are related to the training speech segment, resulting in a plurality of generated speech feature vectors that correspond respectively to the plurality of training speech segments, and
use the automatic encoding model to generate, for each training speech segment of the plurality of training speech segments, an encoded generated speech feature vector based on the generated speech feature vector that corresponds to the training speech segment, resulting in a plurality of encoded generated speech feature vectors that correspond respectively to the plurality of training speech segments;
generate, for each training speech segment of the plurality of training speech segments, a generated training dataset including the encoded generated speech feature vector that is related to the training speech segment, and the plurality of first word feature vectors that are related to the series of words of the natural language text associated with the training speech segment, resulting in a plurality of generated training datasets that correspond respectively to the plurality of training speech segments, and
use the plurality of true training datasets and the plurality of generated training datasets to train a recurrent neural network (RNN), so as to obtain a trained RNN that serves as the speech recognition model.

11. The computer device as claimed in claim 10, wherein the processor is further programmed to, after obtaining the number of speech feature vectors, use the plurality of speech feature vectors to train a generative adversarial network, so as to obtain the speech generator model.

12. The computer device as claimed in claim 10, wherein the processor is further programmed to, prior to obtaining the trained RNN:
generate, for each training speech segment of the plurality of training speech segments, an altered speech segment using a speech alteration algorithm, resulting in a plurality of altered speech segments that correspond respectively to the plurality of training speech segments;
obtain, for each altered speech segment of the plurality of altered speech segments, a number of altered speech feature vectors that are related to the altered speech segment using the speech feature extraction algorithm;
generate, for each training speech segment of the plurality of training speech segments, an encoded altered speech feature vector based on the number of altered speech feature vectors that correspond to the training speech segment;
generate, for each training speech segment of the plurality of training speech segments, an altered training dataset including the encoded altered speech feature vector that is related to the training speech segment, and the first word feature vectors that are related to the series of words of the natural language text associated with the training speech segment, resulting in a plurality of altered training datasets;
wherein the RNN is trained further using the plurality of altered training datasets.

13. The computer device as claimed in claim 9, wherein the processor is further programmed to:
obtain, for each of the converted string, a plurality of estimated probabilities; and
obtain the finalized converted text transcription by
constructing an initial converted text transcription by stringing together the converted strings based on the sequential order of the plurality of input speech segments,
determining whether any one of the words in the initial converted text transcription needs adjustment by determining whether each of the plurality of estimated probabilities is below a predetermined probability threshold, and
in the case that at least one of the plurality of estimated probabilities is below the predetermined probability threshold, implementing an adjustment operation on the initial converted text transcription, so as to obtain the finalized converted text transcription.

14. The computer device as claimed in claim 13, wherein:
the data storage further stores a plurality of training semantic datasets, each of the plurality of training semantic datasets includes a semantically incorrect sentence and a semantically correct sentence that corresponds with the semantically incorrect sentence, each of the semantically incorrect sentence and the semantically correct sentence including a sequence of words,
the processor is further programmed to, prior to implementing an adjustment operation on the initial converted text transcription,
obtain, from the semantically incorrect sentence of each of the plurality of training semantic datasets, a plurality of second word feature vectors that are related to the series of words of the semantically incorrect sentence, respectively,
obtain, from the semantically correct sentence of each of the plurality of training semantic datasets, a plurality of third word feature vectors that are related to the series of words of the semantically correct sentence, respectively,
generate, for each training semantic dataset of the plurality of training semantic datasets, a training semantic feature dataset including the second word feature vectors and the third word feature vectors that correspond to the training semantic dataset, resulting in a plurality of training semantic feature datasets corresponding respectively to the plurality of training semantic datasets, and
use the training semantic feature datasets to train another RNN, so as to obtain another trained RNN that serves as a semantic adjustment model;
wherein the adjustment operation is implemented using the semantic adjustment model.

15. The computer device as claimed in claim 13, wherein the processor is further programmed to, in the case that none of the words in the initial converted text transcription need adjustment, output the initial converted text transcription as the finalized converted text transcription.

16. The computer device as claimed in claim 13, wherein the adjustment operation is implemented using a semantic adjustment model that includes a large language model (LLM).
